(19) United States
(12) Patent Application Publication
(10) Pub. No.: US 2025/0219052 A1
(43) Pub. Date: Jul. 3, 2025

(54) NEGATIVE ELECTRODE PLATE FOR LITHIUM BATTERY AND LITHIUM-ION SECONDARY BATTERY INCLUDING SAME

(71) Applicant: MURATA MANUFACTURING CO., LTD., Kyoto (JP)

(72) Inventors: Yan ZHOU, Shanghai (CN); Li WANG, Shanghai (CN); Kazumasa TAKESHI, Shanghai (CN); Yuli LI, Shanghai (CN)

(21) Appl. No.: 18/802,306

(22) Filed: Aug. 13, 2024

(30) Foreign Application Priority Data
Sep. 27, 2023 (CN) 2023112664445

(51) Int. Cl. H01M 4/36; H01M 4/02; H01M 4/133; H01M 4/134; H01M 4/38; H01M 4/583; H01M 4/62; H01M 10/0525

(52) U.S. Cl. CPC H01M 4/364; H01M 4/133; H01M 4/134; H01M 4/386; H01M 4/583; H01M 4/622; H01M 4/625; H01M 10/0525; H01M 2004/021; H01M 2004/027

(57) ABSTRACT

A negative electrode plate for a lithium battery and a lithium-ion secondary battery including same are provided. The negative electrode plate includes a negative electrode current collector and a negative electrode material. The negative electrode material includes: a negative electrode active material including graphite and a silicon-based material; a conductive agent; a binder including carbon nanotubes; and a dispersing agent including one or both of lignosulfonate and humic acid.

### CROSS REFERENCE TO RELATED APPLICATIONS

The present application claims priority to Chinese patent application no. 2023112664445, filed on Sep. 27, 2023, the entire contents of which is herein incorporated by reference.

### BACKGROUND

The present disclosure relates to lithium ion technology, and in particular to a negative electrode plate for a lithium battery and a lithium-ion secondary battery including same.

Among the negative electrode materials of lithium-ion batteries, blending graphite with a silicon-based material is an effective method to improve the energy density of lithium-ion batteries. At present, the silicon-based material on the market can be divided into silicon monoxide (such as disproportionated silicon monoxide, amorphous silicon monoxide, and high initial efficiency silicon monoxide) and silicon-carbon material. Compared with other materials, the amorphous silicon monoxide materials have the advantages of low price, low expansion, and high capacity, etc., however they have poor cycle performance, and thus have not been valued by the market. To solve the problem of poor cycle performance of such materials, carbon nanotubes can be added to the slurry to improve the performance. However, this method has the risk of poor dispersion of carbon nanotubes and low effective utilization of carbon nanotubes, and requires additional equipment, resulting in increased production costs. In addition, water-based negative electrode plates are prone to bubble formation during the production process of slurry, which can lead to exposed foil and particle aggregation during coating, thereby affecting service life and cycle performance of the battery. To solve the above problems, patents CN102810662 and CN109301250 disclose the addition of alcohol and ether materials, however such methods are of relatively high costs and not environmentally friendly.

Given the existence of the above problems, it is necessary to develop a negative electrode plate and a lithium-ion secondary battery comprising same that can improve the cycle performance of lithium-ion batteries and improve the dispersibility of electrode slurry.

### SUMMARY

The present disclosure relates to providing, in an embodiment, a negative electrode plate for a lithium battery and a lithium-ion secondary battery including same. The present lithium battery technology relates to solving problems, for example, of poor cycle performance and dispersion of the negative electrode materials for lithium batteries in the existing technology, according to an embodiment.

In an embodiment, the present disclosure provides a negative electrode plate for a lithium battery, which includes a negative electrode current collector and a negative electrode material, the negative electrode material includes: a negative electrode active material including graphite and a silicon-based material; a conductive agent; a binder including carbon nanotubes; and a dispersing agent including one or two of lignosulfonate and humic acid.

Further, the silicon-based material comprises one or two of silicon monoxide and a silicon-carbon composite material, preferably amorphous silicon monoxide, according to an embodiment.

Further, the particle size D₅₀ of the silicon monoxide is 1 μm<D₅₀<10 μm, and wherein the particles of particle size of <3 μm account for 5% to 30%, and the size of the silicon grains in the silicon monoxide is <1 nm, according to an embodiment.

Further, the graphite is selected from natural graphite, artificial graphite, or a mixture thereof; the ratio of the peak intensity of peak D to peak G in the Raman spectrum of the graphite, D/G is in a range of 0.04-1, preferably 0.3-0.9; and the graphite has a conductivity of >300 s/cm, preferably >400 s/cm, as measured according to the four-point probe test method at a pressure of 130 MPa, according to an embodiment.

Further, the conductive agent comprises conductive carbon black, conductive graphite, and vapor grown carbon fiber, or a combination of two or more thereof, and preferably the amount of the conductive agent in the negative electrode material is 1% to 3% by weight, based on the total solid weight of the negative electrode material, according to an embodiment.

Further, the binder comprises polyvinylidene difluoride, polyacrylic acid, styrene-butadiene rubber, and carboxymethyl cellulose binder, or a combination of two or more thereof, preferably polyacrylic acid binder; and preferably the amount of the binder in the negative electrode material is 2% to 4% by weight, based on the total solid weight of the negative electrode material, according to an embodiment.

Further, the dispersing agent comprises lignosulfonate, preferably sodium lignosulfonate; and preferably the amount of the dispersing agent in the negative electrode material is 0.2% to 3% by weight, based on the total solid weight of the negative electrode material, according to an embodiment.

Further, the viscosity of the binder is in a range of 400-30000 mPa·s, and preferably 3000-20000 mPa·s, according to an embodiment.

Further, based on the quality of the binder, the content of the carbon nanotubes contained in the binder is 0.01%-1%, preferably 0.02%-0.3%, according to an embodiment.

Yet another embodiment of the present disclosure provides a lithium-ion secondary battery comprising a positive electrode plate, a negative electrode plate, a separator, and an electrolyte, wherein the negative electrode plate is the negative electrode plate described above.

By using the present technology, the problems of poor cycle of a silicon-based material, and exposed foil and particle agglomeration of water-based negative electrode slurry, and the like, can be overcome by using graphite and a silicon-based material, combined with a conductive binder and a dispersing agent including one or two of lignosulfonate and humic acid, according to an embodiment.

### BRIEF DESCRIPTION OF THE FIGURES

The accompanying drawings of the description, which form a part of the present application, are used to provide a further understanding of the present disclosure according to an embodiment.

FIG. 1 is an SEM image of the negative electrode material, with the two images on the left showing an embodiment of directly adding carbon nanotubes to the negative electrode slurry, and the two images on the right showing an embodiment of adding carbon nanotubes to the binder.

FIG. 2 is an image of the negative electrode plate, with the two images on the left showing an embodiment where the negative electrode material uses conventional PAA binder and has no lignosulfonate, and the two images on the right showing the embodiment where the negative electrode material uses the conductive PAA binder containing carbon nanotubes and contains sodium lignosulfonate.

### DETAILED DESCRIPTION

It should be noted that the examples and features in the examples in the present application can be combined with each other according to an embodiment. The present disclosure will be described in further detail below including in conjunction with examples according to an embodiment.

As described in the background section, the negative electrode materials used for lithium batteries in the existing technologies have problems of poor cycle performance and dispersibility. In order to solve the above-mentioned technical problems, the present application, in an embodiment, provides a negative electrode plate for a lithium battery, which includes a negative electrode current collector and a negative electrode material, the negative electrode material includes: a negative electrode active material including graphite and a silicon-based material; a conductive agent; a binder including carbon nanotubes; and a dispersing agent including one or two of lignosulfonate and humic acid.

In the present disclosure, in an embodiment, graphite and silicon-based materials are used as negative electrode active materials, and the performance of the mixed electrode is improved by combining with a binder containing carbon nanotubes and lignosulfonic acid and/or humic acid dispersing agents having a dispersion function. Silicon-based materials, especially amorphous silicon oxide materials, have poor cycle performance due to their poor conductivity and high lithium intercalation capacity. Moreover, in a mixed system of graphite and silicon-based materials, the capacity performance is closely related to the type of graphite, binder, type of conductive agent, and dispersing agent, etc., and thus it is necessary to study on how to achieve their performance in the mixed electrode.

In the present disclosure, in an embodiment, graphite and silicon-based materials are used as negative electrode active materials. Some silicon-based materials can be distributed among graphite particles, which plays a certain role in inhibiting the expansion of silicon-based materials. Graphite with high conductivity can contribute to conductivity, which is thus conducive to the electrochemical performance of the silicon-based materials. A binder containing carbon nanotubes can form numerous chemical bonds with silicon-based materials, enhancing the connections among particles, and providing more conductive networks. Carbon nanotubes are distributed in the binder, which facilitates the distribution of carbon nanotubes on the surface of graphite particles, the surface of silicon-based material particles, and among particles simultaneously, greatly improving the effective utilization of carbon nanotubes, increasing ion and electron transport rates, and promoting the electrochemical performance of the silicon-based materials. The lignosulfonate or humic acid contained in the dispersing agent contains functional groups such as carboxyl, hydroxyl, and sulfo groups, which have a certain surface activity effect and are conducive to the dispersion of the slurry, meanwhile they can reduce the polarity of the binder, thereby improving the compatibility of graphite, silicon-based materials, and binders, and also have a certain defoaming effect, thereby reducing the phenomenon of exposed foil.

In an embodiment, the silicon-based material comprises one or two of silicon monoxide and a silicon-carbon composite material, preferably amorphous silicon monoxide. Using silicon monoxide as a silicon-based material is more conducive to obtaining a negative electrode material with good performance.

In an embodiment, the particle size D₅₀ of the silicon monoxide is 1 μm<D₅₀<10 μm, and wherein the particles of particle size of <3 μm account for 5% to 30%, and the size of the silicon grains in the silicon monoxide is <1 nm.

The inventors found that the particle size of silicon monoxide within the above range can alleviate the expansion of negative electrode materials during battery charging and improve the cycle life of the battery. If the particle size is too large, it will cause a significant volumetric effect, exacerbating the expansion of the negative electrode plate during battery charging. If the particle size is too small, the particles of the negative electrode active material are not easily dispersed, which will affect the dispersion performance of the slurry and may lead to increased side reactions of the battery.

In an embodiment, the graphite is selected from natural graphite, artificial graphite, or a mixture thereof; the ratio of the peak intensity of peak D to peak G in the Raman spectrum of the graphite, D/G is in a range of 0.04-1, preferably 0.3-0.9; and the graphite has a conductivity of >300 s/cm, preferably >400 s/cm, as measured according to the four-point probe test method at a pressure of 130 MPa. The D/G of graphite refers to the ratio of the peak intensity of peak D to peak G in the Raman spectrum of the graphite, wherein the peak D in the Raman spectrum of the graphite is a disordered peak caused by the sp2 of graphite, originated from the vibration of the carbon crystalline edge of graphite, located near a wavelength of 1360 cm⁻¹; the peak G in the Raman spectrum of the graphite is a typical Raman peak of bulk crystalline graphite, located near the wavelength of 1585 cm⁻¹, which is the fundamental vibration mode of graphite crystals. The use of graphite with specific parameters within a specific range is more conducive to obtaining a negative electrode material with good performance.

In an embodiment, the conductive agent comprises conductive carbon black, conductive graphite, and vapor grown carbon fiber, or a combination of two or more thereof, and preferably the amount of the conductive agent in the negative electrode material is 1% to 3% by weight, based on the total solid weight of the negative electrode material. Using a specific proportion of conductive agent such as conductive carbon black is more conducive to obtaining a negative electrode material with good performance.

In an embodiment, the binder comprises polyvinylidene difluoride, polyacrylic acid, styrene-butadiene rubber, and carboxymethyl cellulose binder, or a combination of two or more thereof, preferably polyacrylic acid binder; and preferably the amount of the binder in the negative electrode material is 2% to 4% by weight, based on the total solid weight of the negative electrode material. Using a specific proportion of binder such as polyacrylic acid is more conducive to obtaining a negative electrode material with good performance.

The dispersing agent comprises one or two of lignosulfonate and humic acid. In a preferred embodiment, the humic acid includes one or more of fulvic acid, ulmic acid, and humus acid, preferably fulvic acid. In a preferred embodiment, the dispersing agent comprises lignosulfonate, preferably sodium lignosulfonate; and preferably the amount of the dispersing agent in the negative electrode material is 0.2% to 3% by weight, based on the total solid weight of the negative electrode material. Using a specific proportion of dispersing agent such as sodium lignosulfonate is more conducive to obtaining a negative electrode material with good performance. Wherein, if the content of the dispersing agent is too low, it cannot achieve good dispersion effect; and if the content of the dispersing agent is too high, it will affect the electrical performance such as capacity and cycle performance of the battery, etc.

In an embodiment, the viscosity of the binder is in a range of 400-30000 mPa·s, and preferably 3000-20000 mPa·s. The use of a binder with specific viscosity, such as polyacrylic acid, can ensure that the electrode slurry has no processability problems while improving the electrical performance of the battery. If the viscosity of the binder is too low, it will lead to a decrease in stability of the slurry, and at the same time, it cannot exert good bonding effect, which may result in powder falling off from electrode plate, and can cause problems of short circuits and poor cycle performance of the battery. If the viscosity of the binder is too high, it will cause difficulty in dispersing the slurry, resulting in particle aggregation and failing to produce electrode plate.

In an embodiment, based on the mass of the binder, the content of the carbon nanotubes comprised in the binder is 0.01% to 1%, and preferably 0.02% to 0.3%. If the content of carbon nanotubes in the binder is too low, it cannot effectively improve the electrical performance of the battery; and if the content of carbon nanotubes is too high, the dispersibility of carbon nanotubes will deteriorate, resulting in limited improvement in battery performance, but significantly increased costs.

Another embodiment of the present application provides a lithium-ion secondary battery comprising a positive electrode plate, a negative electrode plate, a separator, and an electrolyte, wherein the negative electrode plate is the negative electrode plate described above.

The lithium-ion secondary battery of the present disclosure, in an embodiment, is prepared as described in further detail below.

Preparation of negative electrode plate: the negative electrode active material, conductive agent, binder, dispersing agent, and solvent are stirred to prepare a negative electrode slurry. Then, the negative electrode slurry is coated onto the negative electrode current collector, dried and stamping molded to form a negative electrode plate.

Preparation of electrolyte: an organic solvent, a lithium salt, and an additive are mixed to prepare the electrolyte.

Battery assembly: the prepared negative electrode plate, separator, lithium sheet, and battery shell are stacked in sequence and filled with 100 ml of electrolyte, which are then sealed and assembled into a half cell.

The present application will be further described in detail below in combination with specific examples according to an embodiment.

Sodium lignosulfonate was dissolved in water, then amorphous silicon monoxide was added and stirred until mixed uniformly, after which a conductive binder in an amount of 50% of the total amount of binder was added and mixed uniformly, a conductive carbon black was added and stirred until mixed uniformly, then a required amount of graphite and the remaining amount of binder were added, stirred and mixed, finally water was added to adjust the solid content until a state capable of film-drawing was achieved. Herein, the binder used is a polyacrylic acid (PAA) binder, and the conductive binder is a binder containing a certain amount of carbon nanotubes in the PAA binder. In some examples, the carbon nanotubes were directly added to the negative electrode slurry without using a conductive binder, as shown in Table 1. The negative electrode slurry was coated onto the copper foil, which was oven-dried and die-cut, and the prepared negative electrode plate was placed in a vacuum drying oven for 5 hours before taking out for battery assembly. The prepared negative electrode plate, a separator, a gasket, and a battery housing were stacked in sequence and filled with 100 ml of electrolyte, which were then sealed and assembled into a half cell. The masses of silicon monoxide, graphite, binder (including a conductive binder), and conductive carbon black in the negative electrode plate were 19 g, 76.2 g, 3 g, and 0.8 g, respectively. The graphite used in the examples has a D/G of 0.7 and a conductivity of 560 s/cm as measured according to the four-point probe test method at a pressure of 130 MPa. The particle size D₅₀ of silicon monoxide used in the examples was 4.5 μm, wherein particles of a particle size of <3 μm accounted for 20%, and the size of silicon grains was <1 nm. The viscosity and carbon nanotube content (based on the mass of the binder) of the binder used in the examples, as well as the content of sodium lignosulfonate (based on the mass of the negative electrode material) are shown in Table 1.

The initial discharge capacity, initial efficiency, and capacity retention rate after cycling of the battery were tested using the following methods. Capacity testing: the charge-discharge test was carried out on the battery at a charge-discharge rate of 0.1 C and a charge-discharge voltage in a range of 0V-1.5V so as to obtain the initial capacity and the initial efficiency. Cycle testing: after the capacity testing was completed, the battery was charged at a current of 0.1 C, and then a charge-discharge cycle testing was carried out at a current of 1 C to test the capacity retention rate after 50 cycles. The charge-discharge cut-off voltage was 0 V-1.5 V. The test results are shown in Table 1.

TABLE 1

| | | | | | | | | Capacity |
|---|---|---|---|---|---|---|---|---|
| | | | Content | | State of | | | retention |
| | Binder | | of carbon | | slurry | Initial | | rate |
| | | Content | nanotube in | Content of | and | discharge | | after |
| | Viscosity | of carbon | slurry, | sodium | electrode | capacity, | Initial | 50 |
| Example | mPa · s | nanotube, % | % | lignosulfonate, % | plate | mAh/g | efficiency, % | cycles, % |
| Example | 20000 | 0.05 | 0 | 1 | No | 643 | 82.6 | 95 |
| 1 | | | | | particle | | | |
| | | | | | aggregation, | | | |
| | | | | | and no | | | |
| | | | | | exposed | | | |
| | | | | | foil on | | | |
| | | | | | electrode | | | |
| | | | | | plate | | | |
| Example | 20000 | 0.1 | 0 | 1 | No | 643 | 82.7 | 96 |
| 2 | | | | | particle | | | |
| | | | | | aggregation, | | | |
| | | | | | and no | | | |
| | | | | | exposed | | | |
| | | | | | foil on | | | |
| | | | | | electrode | | | |
| | | | | | plate | | | |
| Comparative | 35000 | 0.05 | 0 | 0.5 | Severe | \ | \ | \ |
| example | | | | | particle | | | |
| 1 | | | | | aggregation, | | | |
| | | | | | unable to | | | |
| | | | | | produce | | | |
| | | | | | electrode | | | |
| | | | | | plate | | | |
| Comparative | 20000 | 0 | 0 | 0 | No | 620 | 81 | 48 |
| example | | | | | particle | | | |
| 2 | | | | | aggregation, | | | |
| | | | | | exposed | | | |
| | | | | | foil on | | | |
| | | | | | electrode | | | |
| | | | | | plate | | | |
| Comparative | 20000 | 1.2 | 0 | 1 | No | 638 | 82.4 | 88 |
| example | | | | | particle | | | |
| 3 | | | | | aggregation, | | | |
| | | | | | and no | | | |
| | | | | | exposed | | | |
| | | | | | foil on | | | |
| | | | | | electrode | | | |
| | | | | | plate | | | |
| Comparative | 20000 | 0 | 0.05 | 1 | No | 625 | 82 | 92 |
| example | | | | | particle | | | |
| 4 | | | | | aggregation, | | | |
| | | | | | and no | | | |
| | | | | | exposed | | | |
| | | | | | foil on | | | |
| | | | | | electrode | | | |
| | | | | | plate | | | |
| Comparative | 20000 | 0.05 | 0 | 0 | No | 630 | 82 | 85 |
| example | | | | | particle | | | |
| 5 | | | | | aggregation, | | | |
| | | | | | exposed | | | |
| | | | | | foil on | | | |
| | | | | | electrode | | | |
| | | | | | plate | | | |
| Comparative | 20000 | 0.1 | 0 | 5% | No | 628 | 80 | 70 |
| example | | | | | particle | | | |
| 6 | | | | | aggregation, | | | |
| | | | | | and no | | | |
| | | | | | exposed | | | |
| | | | | | foil on | | | |
| | | | | | electrode | | | |
| | | | | | plate | | | |
| Comparative | 300 | 0.1 | 0 | 1 | No | \ | \ | \ |
| example | | | | | adhesion on | | | |
| 7 | | | | | electrode | | | |
| | | | | | plate, | | | |
| | | | | | powder | | | |
| | | | | | fall off, | | | |
| | | | | | unable to | | | |
| | | | | | produce | | | |
| | | | | | battery | | | |

It can be seen from the above descriptions that the above examples of the present disclosure have achieved the following technical effects according to an embodiment:

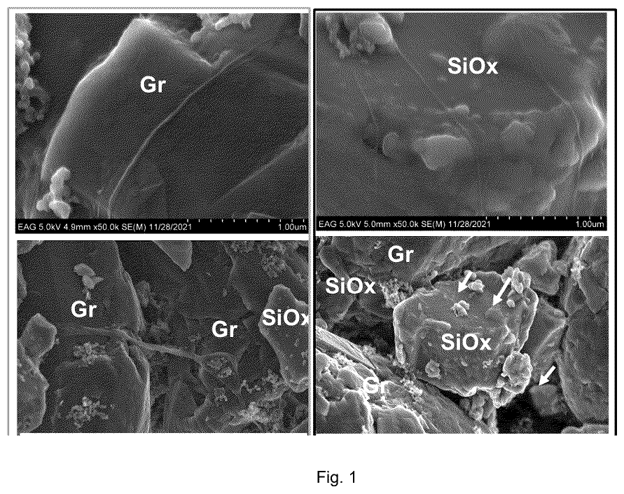

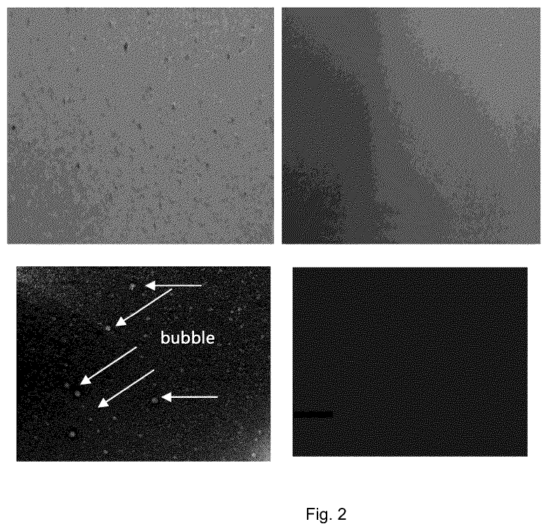

Comparing Examples 1-2 with Comparative examples 1-7, it can be seen that the negative electrode plate for lithium batteries of the present disclosure has improved slurry dispersibility, initial discharge capacity, initial efficiency, and capacity retention rate after cycling. Specifically, comparing Examples 1-2 with Comparative examples 1 and 7, it can be seen that when the viscosity of the binder is not within the range of the present disclosure, it is unable to form a electrode plate. Comparing Examples 1-2 with Comparative examples 2, 4 and 5, it can be seen that relative to the situation where the binder contains no carbon nanotubes (including the situation where the binder contains no carbon nanotubes but the slurry contains carbon nanotubes) and the negative electrode plate contains no dispersing agent, the negative electrode plate for lithium batteries in the present disclosure has improved slurry dispersibility, initial discharge capacity, initial efficiency, and capacity retention rate after cycling. In addition, referring to FIG. 1, it can be seen from FIG. 1 that in the embodiment where carbon nanotubes are directly added to the negative electrode slurry, for example, in Comparative example 4, due to the different surface characteristics of different materials, most of the carbon nanotubes can only be distributed on the surface of graphite, among graphite and amorphous silicon monoxide particles, resulting in poor performance of the amorphous silicon monoxide material. In the embodiment where the carbon nanotubes are added to the binder, for example in Example 1, a conductive binder with carbon nanotubes compounded in the binder is used, the carbon nanotubes accompanying with the binder can achieve uniform distribution, and are distributed on the surface of graphite, the surface of amorphous silicon particles, and among graphite and amorphous silicon monoxide particles, greatly improving the utilization rate of carbon nanotubes and promoting the improvement in properties of silicon-based materials. Referring to FIG. 2, it can be seen from FIG. 2 that in the embodiment where conventional PAA binder without lignosulfonate is used in the negative electrode material, for example in Comparative example 2, a large number of bubbles appeared in the slurry coated on the surface of the electrode plate, leading to exposed foil on electrode plate, while in the embodiment where conductive PAA binder containing carbon nanotubes and sodium lignosulfonate is used in the negative electrode material, for example in Example 1, bubble generation is significantly suppressed and no exposed foil occurs. In addition, comparing Examples 1-2 with Comparative examples 3 and 6, it can be seen that the negative electrode plate having a specific content of carbon nanotubes and dispersing agents of the present disclosure has improved slurry dispersibility, initial discharge capacity, initial efficiency, and capacity retention rate after cycling.

In addition, the negative electrode materials and batteries of Example 3 and Comparative Examples 8-10 were also prepared using the same method as Example 1 but different graphite or silicon monoxide materials, and the initial discharge capacity, initial efficiency, and capacity retention rate after cycling of the batteries were tested using the same method as described above. The test results are shown in Table 2.

TABLE 2

| | | | Parameters of silicon | | | | | |
|---|---|---|---|---|---|---|---|---|
| | | | monoxide | | | | | Capacity |
| | | | Size | | | | | retention |
| | Parameters of | | of | Particle | | Initial | | rate |
| | graphite | | silicon | size | Particles | discharge | Initial | after 50 |
| | | Conductivity, | grains, | D50 | of <3 | capacity, | efficiency, | cycles, |
| Examples | D/G | S/cm | nm | μm | μm, % | mAh/g | % | % |
| Example 1 | 0.7 | 560 | <1 | 4.5 | 20 | 643 | 82.6 | 95 |
| Example 3 | 0.36 | 360 | <1 | 4.5 | 20 | 633 | 82.3 | 90 |
| Comparative | 0.7 | 560 | 4 | 4.5 | 20 | 611 | 82.8 | 94 |
| example 8 | | | | | | | | |
| Comparative | 0.7 | 560 | <1 | 5.5 | 3 | 644 | 82.5 | 89 |
| example 9 | | | | | | | | |
| Comparative | 0.7 | 560 | <1 | 4 | 35 | 629 | 82.0 | 97 |
| example 10 | | | | | | | | |
| Comparative | 0.05 | 300 | <1 | 4.5 | 20 | 624 | 80.1 | 85 |
| example 11 | | | | | | | | |

Comparing Examples 1 and 3 with Comparative example 8-11, it can be seen that when the parameters of graphite and silicon monoxide used in the negative electrode material are not within the range of the present disclosure, it will lead to a decrease in the initial capacity, initial efficiency, or capacity retention rate after cycling of the battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A negative electrode plate for a lithium battery, the negative electrode plate comprising a negative electrode current collector and a negative electrode material, wherein the negative electrode material includes:
a negative electrode active material comprising a graphite and a silicon-based material;
a conductive agent;
a binder comprising carbon nanotubes; and
a dispersing agent including one or both of lignosulfonate and humic acid.

2. The negative electrode plate of claim 1, wherein the silicon-based material includes one or both of a silicon monoxide and a silicon-carbon composite material.

3. The negative electrode plate of claim 2, wherein a particle size D₅₀ of the silicon monoxide is 1 μm<D₅₀<10 μm, and wherein a particle size of <3 μm account for 5% to 30%, and a size of silicon grains in the silicon monoxide is <1 nm.

4. The negative electrode plate of claim 1, wherein the graphite is natural graphite, artificial graphite, or a mixture thereof, wherein a ratio of a peak intensity of peak D to peak G in a Raman spectrum of the graphite, wherein D/G is in a range of 0.04-1, and wherein the graphite has a conductivity of >300 s/cm as measured according to a four-point probe test method at a pressure of 130 MPa.

5. The negative electrode plate of claim 1, wherein the conductive agent includes conductive carbon black, conductive graphite, and vapor grown carbon fiber, or a combination thereof, and wherein an amount of the conductive agent in the negative electrode material is 1% to 3% by weight, based on a total solid weight of the negative electrode material.

6. The negative electrode plate of claim 1, wherein the binder includes polyvinylidene difluoride, polyacrylic acid, styrene-butadiene rubber, and carboxymethyl cellulose binder, or a combination thereof, and wherein an amount of the binder in the negative electrode material is 2% to 4% by weight, based on a total solid weight of the negative electrode material.

7. The negative electrode plate of claim 1, wherein the dispersing agent includes lignosulfonate, and wherein an amount of the dispersing agent in the negative electrode material is 0.2% to 3% by weight, based on the total solid weight of the negative electrode material.

8. The negative electrode plate of claim 1, wherein a viscosity of the binder is in a range of 400-30000 mPa·s.

9. The negative electrode plate of claim 1, wherein, based on a mass of the binder, a content of the carbon nanotubes in the binder is 0.01% to 1%.

10. A lithium-ion secondary battery comprising a positive electrode plate, a negative electrode plate, a separator, and an electrolyte, wherein the negative electrode plate is the negative electrode plate of claim 1.
